(19) United States
(12) Patent Application Publication
(10) Pub. No.: US 2026/0268428 A1
(43) Pub. Date: Sep. 10, 2026

(54) INFORMATION PROCESSING DEVICE AND INFORMATION PROCESSING METHOD

(71) Applicant: KANRIN CO., LTD, Yokohama-Shi, Kanagawa (JP)

(72) Inventors: Hiroshi NAGAOKA, Yokohama-Shi, Kanagawa (JP); Honji AHAREN, Yokohama-Shi, Kanagawa (JP); Daisuke OGA, Yokohama-Shi, Kanagawa (JP)

(73) Assignee: KANRIN CO., LTD, Yokohama-Shi, Kanagawa (JP)

(21) Appl. No.: 18/027,143

(22) PCT Filed: Nov. 7, 2022
(86) PCT No.: PCT/JP2022/041376

§ 371 Date: Mar. 20, 2023

(51) Int. Cl. G06Q 50/20; G09B 17/00

(52) U.S. Cl. CPC G06Q 50/20; G09B 17/003

(57) ABSTRACT

An information processing device (e.g., a server (10)) includes: a processor 20; a first memory 40 configured to store a program; a second memory 42 configured to store learning target contents and activity details respectively related to the learning target contents; and a third memory 44 configured to store learned contents corresponding to identification information regarding learners. Through execution of the program stored in the first memory 40, the processor 20 is configured to receive, from a terminal of a learner, information on a content having been learned, and cause the third memory 44 to store the received content as a learned content in association with identification information regarding the learner.

### TECHNICAL FIELD

The present invention relates to an information processing device and an information processing method.

### BACKGROUND ART

Hitherto, various systems and devices that assist learning of, for example, linguistics of foreign languages have been known. Japanese Laid-Open Patent Publication No. 2014-038140 (JP2014-038140A) discloses a language-learning assistance device for efficiently strengthening listening ability for non-native languages. Further, Japanese Laid-Open Patent Publication No. 2008-209922 (JP 2008-209922A) discloses highly effective foreign-language learning system and learning method that deal with levels of learners.

### SUMMARY OF THE INVENTION

Hitherto, there has been no device or method that output information highly convenient for a learner and an activity entity by using learning target contents for each activity detail and learned contents of each learner. In addition, although it is desired to improve the learning efficiency when a learner learns a content, there has been no such device or method.

An object of the present invention is to provide an information processing device and an information processing method that can output information highly convenient for a learner and an activity entity by using learning target contents for each activity detail and learned contents of each learner.

Another object of the present invention is to provide an information processing device and an information processing method that can improve the learning efficiency when a learner learns a content.

An information processing device of the present invention includes: a processor; a first memory configured to store a program; a second memory configured to store learning target contents and activity details respectively related to the learning target contents; and a third memory configured to store learned contents corresponding to identification information regarding learners. Through execution of the program stored in the first memory, the processor is configured to receive, from a terminal of a learner, information on a content having been learned, and cause the third memory to store the received content as a learned content in association with identification information regarding the learner.

In the information processing device of the present invention, through execution of the program stored in the first memory, the processor may: receive identification information regarding a learner and information on an activity detail; extract, based on the information stored in the second memory and the third memory, a learned content related to the received activity detail out of a learned content corresponding to the received identification information regarding the learner; and calculate, based on the extracted learned content, a content mastery degree of the learner with respect to the received activity detail.

In this case, through execution of the program stored in the first memory, the processor may transmit, to a terminal, a display instruction signal for causing the terminal to display the calculated content mastery degree of the learner.

In the information processing device of the present invention, through execution of the program stored in the first memory, the processor may: receive information on identification information regarding a learner; extract, based on the information stored in the third memory, learned contents corresponding to the received identification information regarding the learner; calculate, based on the information stored in the second memory and the extracted learned contents, a content mastery degree of the learner with respect to each activity detail; and output information on said each activity detail in a descending order of the calculated content mastery degree of the learner.

In this case, through execution of the program stored in the first memory, the processor may transmit, to a terminal, a display instruction signal for causing the terminal to display the outputted information on said each activity detail in the descending order of the content mastery degree of the learner.

In the information processing device of the present invention, through execution of the program stored in the first memory, the processor may: receive information on an activity detail; calculate, based on the information stored in the second memory and the third memory, a content mastery degree of each learner with respect to the received activity detail according to the learned contents corresponding to identification information regarding learners; and output identification information regarding said each learner in a descending order of the calculated content mastery degree.

In this case, through execution of the program stored in the first memory, the processor may transmit, to a terminal, a display instruction signal for causing the terminal to display the outputted identification information regarding said each learner in the descending order of the content mastery degree.

In the information processing device of the present invention, the learning target content may include at least one of a vocabulary and a chunk.

In the information processing device of the present invention, the identification information regarding a learner may include an identification number of the learner assigned in advance, an identification number of the terminal of the learner assigned in advance, or a user ID registered in a content learning application installed in the terminal of the learner.

An information processing device of the present invention includes: a processor; a first memory configured to store a program; a second memory configured to store learning target contents and related contents respectively to the learning target contents; and a third memory configured to store learned contents corresponding to identification information regarding learners. Through execution of the program stored in the first memory, the processor is configured to: receive a learning target content and identification information regarding a learner; extract, based on the information stored in the second memory, a related content corresponding to the received learning target content; and output, based on the information stored in the third memory and out of the extracted related content, a learned content corresponding to the received identification information regarding the learner.

In the information processing device of the present invention, through execution of the program stored in the first memory, the processor may transmit, to the terminal of the learner, a display instruction signal for causing the terminal to display the outputted learned content.

In the information processing device of the present invention, the learned contents corresponding to identification information stored in the third memory may also be stored in the second memory. After the related content corresponding to the received learning target content is extracted based on the information stored in the second memory, a learned content corresponding to identification information regarding another learner may also be allowed to be outputted based on the information stored in the second memory and out of the extracted related content.

An information processing device of the present invention includes: a processor; a first memory configured to store a program; and a second memory configured to store learning target contents, related contents respectively to the learning target contents, and activity details respectively related to the learning target contents. Through execution of the program stored in the first memory, the processor is configured to: receive information on a learning target content and an activity detail from a terminal of a learner; extract, based on the information stored in the second memory, a related content corresponding to the received learning target content; and output, out of the extracted related content, a related content corresponding to the received activity detail.

In the information processing device of the present invention, through execution of the program stored in the first memory, the processor may transmit, to the terminal of the learner, a display instruction signal for causing the terminal to display the outputted related content.

In the information processing device of the present invention, the learning target content may include at least one of a part forming a character, a character, a vocabulary, and a chunk.

An information processing method of the present invention is an information processing method performed by an information processing device including a processor, a first memory configured to store a program, a second memory configured to store learning target contents and activity details respectively related to the learning target contents, and a third memory configured to store learned contents corresponding to identification information regarding learners. The information processing method includes: through execution, by the processor, of the program stored in the first memory, receiving identification information regarding a learner and information on an activity detail; extracting, based on the information stored in the second memory and the third memory, a learned content related to the received activity detail out of a learned content corresponding to the received identification information regarding the learner; and calculating, based on the extracted learned content, a content mastery degree of the learner with respect to the received activity detail.

An information processing method of the present invention is an information processing method performed by an information processing device including a processor, a first memory configured to store a program, a second memory configured to store learning target contents and activity details respectively related to the learning target contents, and a third memory configured to store learned contents corresponding to identification information regarding learners. The information processing method includes: through execution, by the processor, of the program stored in the first memory, receiving information on identification information regarding a learner; extracting, based on the information stored in the second memory and the third memory, learned contents corresponding to the received identification information regarding the learner; calculating, based on the extracted learned contents, a content mastery degree of the learner with respect to each activity detail; and outputting information on said each activity detail in a descending order of the calculated content mastery degree of the learner.

An information processing method of the present invention is an information processing method performed by an information processing device including a processor, a first memory configured to store a program, a second memory configured to store learning target contents and activity details respectively related to the learning target contents, and a third memory configured to store learned contents corresponding to identification information regarding learners. The information processing method includes: through execution, by the processor, of the program stored in the first memory, receiving information on an activity detail; calculating, based on the information stored in the second memory and the third memory, a content mastery degree of each learner with respect to the received activity detail according to the learned contents corresponding to identification information regarding learners; and outputting identification information regarding said each learner in a descending order of the calculated content mastery degree.

An information processing method of the present invention is an information processing method performed by an information processing device including a processor, a first memory configured to store a program, a second memory configured to store learning target contents and related contents respectively to the learning target contents, and a third memory configured to store learned contents corresponding to identification information regarding learners. The information processing method includes: through execution, by the processor, of the program stored in the first memory, receiving a learning target content and identification information regarding a learner; extracting, based on the information stored in the second memory, a related content corresponding to the received learning target content; and outputting, based on the information stored in the third memory and out of the extracted related content, a learned content corresponding to the received identification information regarding the learner.

An information processing method of the present invention is an information processing method performed by an information processing device including a processor, a first memory configured to store a program, and a second memory configured to store learning target contents, related contents respectively to the learning target contents, and activity details respectively related to the learning target contents. The information processing method includes: through execution, by the processor, of the program stored in the first memory, receiving information on a learning target content and an activity detail from a terminal of a learner; extracting, based on the information stored in the second memory, a related content corresponding to the received learning target content; and outputting, out of the extracted related content, a related content corresponding to the received activity detail.

### BRIEF DESCRIPTION OF THE DRAWINGS

FIG. 1 is a schematic configuration diagram schematically showing a configuration of an information processing system according to an embodiment of the present invention.

FIG. 2 is a chart showing a flow of information between components in first information processing according to the information processing system shown in FIG. 1.

FIG. 3 is a flowchart showing a flow of the first information processing according to the information processing system shown in FIG. 1.

FIG. 4 is a chart showing a flow of information between components in second information processing according to the information processing system shown in FIG. 1.

FIG. 5 is a flowchart showing a flow of the second information processing according to the information processing system shown in FIG. 1.

FIG. 6 is a chart showing a flow of information between components in third information processing according to the information processing system shown in FIG. 1.

FIG. 7 is a flowchart showing a flow of the third information processing according to the information processing system shown in FIG. 1.

FIG. 8 is a chart showing a flow of information between components in fourth information processing according to the information processing system shown in FIG. 1.

FIG. 9 is a flowchart showing a flow of the fourth information processing according to the information processing system shown in FIG. 1.

FIG. 10 is a chart showing a flow of information between components in fifth information processing according to the information processing system shown in FIG. 1.

FIG. 11 is a flowchart showing a flow of the fifth information processing according to the information processing system shown in FIG. 1.

### DESCRIPTION OF THE PREFERRED EMBODIMENTS

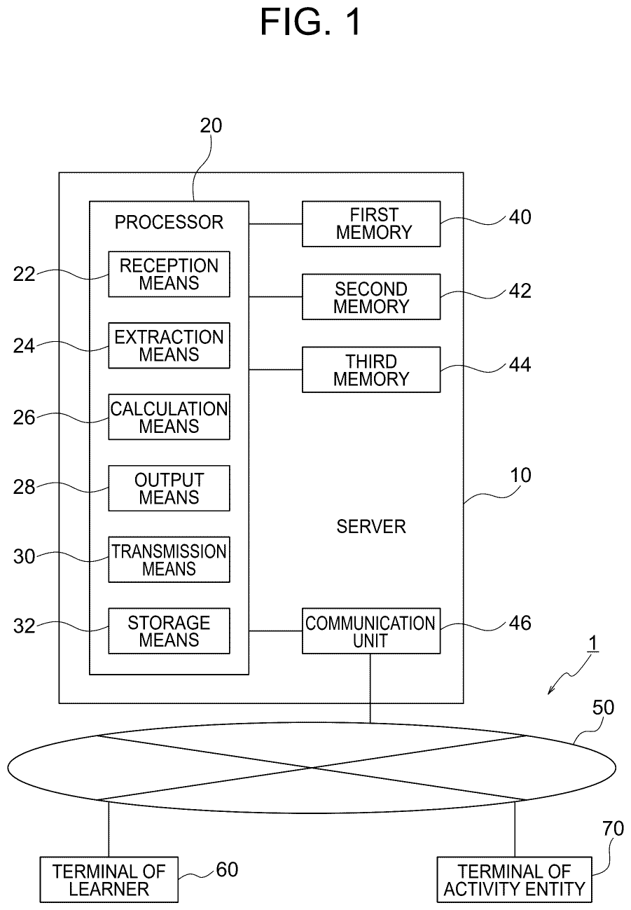

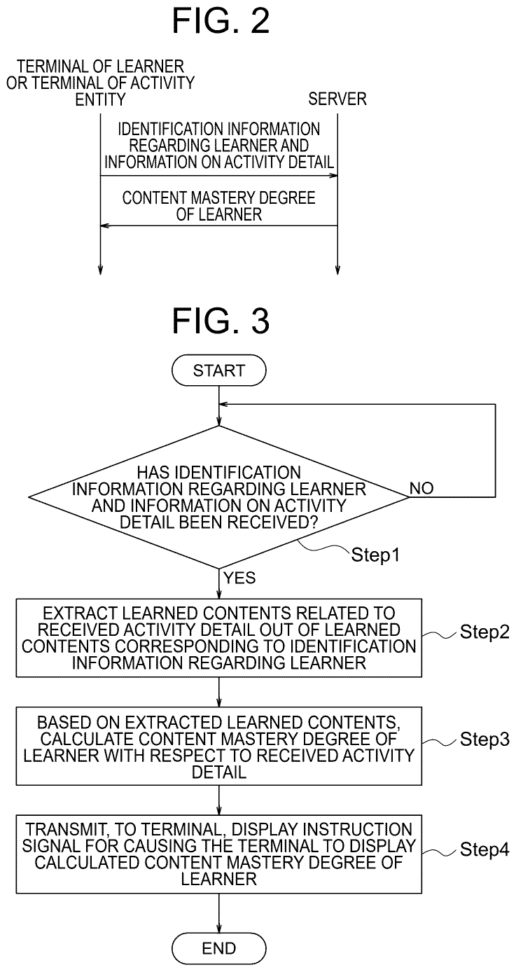

Hereinafter, an embodiment of the present invention will be described with reference to the drawings. FIG. 1 is a schematic configuration diagram schematically showing a configuration of an information processing system according to the present embodiment. FIG. 2 to FIG. 11 are charts showing flows of information between components and flowcharts showing flows of information processing in first to fifth information processing according to the information processing system shown in FIG. 1.

An information processing system 1 of the present embodiment is a system that supports a learner in learning a content such as a language through a terminal 60 of the learner. Specifically, according to the information processing system 1 of the present embodiment, when a content (learning target content) to be learned by a learner is inputted to the terminal 60 of the learner, the terminal 60 of the learner may display a learned content(s) related to the inputted content, thereby allowing repeated learning of the same content. The terminal 60 of the learner may display another related content(s) having the same activity detail as that of the inputted content, thereby allowing collective learning of contents related to a certain activity detail. These make it possible to improve the learning efficiency when a learner learns a content.

The information processing system 1 is a system that supports matching between an activity entity such as an enterprise and a learner who is learning a content related to an activity detail of this activity entity. Specifically, according to the information processing system 1 of the present embodiment, a third memory 44 (described later) stores a content (learned content) having been learned by a learner in such a manner that the content is linked to identification information on this learner. Thus, it is possible to output, by using learning target contents for each activity detail and learned contents of each learner, information highly convenient for a learner and an activity entity. For example, based on learned contents of learners stored in the third memory 44, information regarding the content mastery degree of the learner with respect to a specific activity detail can be obtained. Further, based on learned contents of learners stored in the third memory 44, the content mastery degree of a certain learner with respect to each activity detail can be calculated. Further, based on learned contents of learners stored in the third memory 44, identification information regarding each learner can be outputted in the descending order of the content mastery degree with respect to a certain activity detail.

A configuration of the information processing system 1 will be described below.

The information processing system 1 of the present embodiment includes: a server 10; terminals 60 of learners (in FIG. 1, only one terminal 60 is shown); and terminals 70 of various types of activity entities (in FIG. 1, only one terminal 70 is shown). The server 10 is a server that can be used through an internet line, and is provided in a state where a virtual dedicated server is constructed in a physical server that can be accessed through the Internet. The server 10 can communicate, in a wired or wireless manner, with each of terminals 60 of learners and terminals 70 of activity entities via a communication network 50 such as an internet line. The terminal 60 of each learner is possessed by the learner. As the terminal 60 of a learner, a smartphone, a PC tablet, a personal computer, or the like is used, for example. In the present embodiment, a learner can learn, for example, a language through the terminal 60 of the learner. The terminals 70 of activity entities are installed at offices or the like of various types of activity entities, and are operated by staff members or the like of the activity entities. As the terminal 70 of an activity entity, a smartphone, a PC tablet, a personal computer, or the like is used, for example.

The server 10 includes a processor 20, a first memory 40, a second memory 42, the third memory 44, and a communication unit 46. The first memory 40, the second memory 42, the third memory 44, and the communication unit 46 are each connected to the processor 20. The processor 20 can transmit/receive, via the communication unit 46, a signal to/from each of terminals 60 of learners and terminals 70 of activity entities through the communication network 50 such as an internet line. The first memory 40 is configured to store a program to be executed by the processor 20. The second memory 42 is configured to store all learning target contents, related contents respectively to the learning target contents, and activity details respectively related to the learning target contents. The third memory 44 is configured to store learned contents corresponding to identification information regarding learners.

The processor 20 is configured to execute a program stored in the first memory 40, thereby functioning as reception means 22, extraction means 24, calculation means 26, output means 28, transmission means 30, and storage means 32. The reception means 22 receives various types of information from each of terminals 60 of learners and terminals 70 of activity entities. Based on information stored in the second memory 42 and the third memory 44, the extraction means 24 extracts, out of learned contents corresponding to identification information regarding a learner received by the reception means 22, a learned content(s) related to a received activity detail. Based on the extracted learned content(s), the calculation means 26 calculates the content mastery degree (0% to 100%) of the learner with respect to the received activity detail. Further, based on the information stored in the second memory 42 and the third memory 44, the extraction means 24 may extract a learned content(s) corresponding to identification information regarding a learner received by the reception means 22, and the calculation means 26 may calculate the content mastery degree of the learner with respect to each activity detail based on the learned content(s) extracted by the extraction means 24. In this case, the output means 28 outputs information on each activity detail in the descending order of the calculated content mastery degree of the learner. Further, based on the information stored in the second memory 42 and the third memory 44, the calculation means 26 may calculate the content mastery degree of each learner with respect to an activity detail received by the reception means 22 according to the learned contents corresponding to identification information regarding learners, and the output means 28 may output identification information regarding each learner in the descending order of the calculated content mastery degree. The transmission means 30 transmits various information to each of terminals 60 of learners and terminals 70 of activity entities. The storage means 32 causes the second memory 42 and the third memory 44 to store various information. Details of the functions of these means 22, 24, 26, 28, 30, 32 will be described later.

A learning target content is a content to be learned by a learner through a terminal 60 of the learner. The learning target content is stored, as an initial setting, in the second memory 42. The learning target content includes at least one of a part forming a character, a character, a vocabulary, and a chunk. A part forming a character is a part of a certain character (e.g., a radical or the like in a Chinese character). A character is a symbol in which a sound and a meaning are connected together to represent a specific word. A vocabulary is a collection of words used in a certain specific range. A chunk is an assembly of vocabularies that means a collective body of information recognized by humans. Each learner can input a learning target content to a terminal 60 of the learner. When a learning target content is inputted to the terminal 60 of a learner, this learning target content is transmitted from the terminal 60 of the learner to the server 10.

A learned content is a content having been learned by a learner through the terminal 60 of the learner. The learned content is linked to identification information related to a learner and stored in the third memory 44. The learned content includes at least one of a part forming a character, a character, a vocabulary, and a chunk. When a learner uses the terminal 60 of the learner to learn a certain content out of learning target contents stored in the second memory 42, the storage means 32 causes the third memory 44 to store this content as a learned content such that the content is associated with identification information related to the learner.

Related contents are other contents respectively related to learning target contents. Specifically, a related content is a content related to the corresponding learning target content in terms of pronunciation, shape, or meaning. Being related to a learning target content in terms of pronunciation means being included in the same category among various categories in phonetics (e.g., a category of unvoiced sound/voiced sound, a category based on difference in accent). Being related to a learning target content in terms of shape means: being partially included as a component; and having a similar shape. Being related to a learning target content in terms of meaning means: having the same meaning; having an opposite meaning; having a meaning of a superordinate concept; having a meaning of a subordinate concept; being at the same level in a category of the same concept; and having a causal relationship or an order relationship.

For example, when the learning target content is a part forming a character, the related content is: another part related in terms of shape to the part forming a character of the learning target content; or a character including the part forming a character of the learning target content. When the learning target content is a character, the related content is another character that is the same as or similar to the character of the learning target content in terms of pronunciation or shape, or another character that is related thereto. When the learning target content is a character, the related content may be a vocabulary including the character constituting the vocabulary as the learning content. When the learning target content is a vocabulary, the related content is: another vocabulary that is the same as, similar to, or related to, the vocabulary as the learning target content, in terms of pronunciation; another vocabulary that is the same as, similar to, or related to, the vocabulary as the learning target content in terms of shape; or another vocabulary whose meaning has a synonym or antonym relationship, an inclusion relationship such as being superordinate or subordinate, the same-level relationship, a causal or context relationship, or the like, with the vocabulary as the learning target content. When the learning target content is a chunk, the related content is another chunk that is similar to the chunk as the learning target content in terms of shape, or another chunk that is similar to or related to the chunk as the learning target content in terms of meaning.

The related content may be stored, as an initial setting, in the second memory 42. Alternatively, the learner may be allowed to input information regarding the related content through the terminal 60 of the learner. Here, information regarding the related content includes information indicating that the related content is related to a learning target content stored in the second memory 42, and information regarding the aspect of the relation. The information regarding the related content inputted by the learner through the terminal 60 of the learner is linked to identification information regarding the learner and stored into the third memory 44. The information regarding the related content stored in the third memory 44 may also be stored in the second memory 42. In this case, the learner can utilize information regarding a related content inputted by another learner.

Identification information related to a learner is information for distinguishing a certain learner from another learner. The identification information related to a learner includes an identification number of the learner assigned in advance, an identification number of the terminal 60 of the learner assigned in advance, a user ID registered in a content learning application installed in the terminal 60 of the learner, or the like.

An activity detail includes, for example, any of: the type of business run by a corporation or an individual; the type of job; an education detail provided by an educational institution; and an examination detail provided by an educational institution. When the activity detail is the type of business run by a corporation or an individual, the activity detail includes, for example, construction industry, caregiving industry, medical industry, tourism industry, and the like. When the activity detail is the type of job, the activity detail includes, for example, sales, reception, office work, cleaning, cooking, driver, helper, and the like. When the activity detail is an education detail provided by an educational institution, the activity detail includes, for example, the type of language, the level of language, a content of a curriculum of the educational institution, and the like. When the activity detail is an examination detail, the activity detail includes, for example, the type of examination, the type of language to be examined, the level of language to be examined, and the like.

An activity entity is an entity implementing an activity detail. The activity entity includes a corporation and an individual. When the activity detail is, for example, construction industry, caregiving industry, medical industry, or tourism industry, the activity entity is a construction company, a caregiving facility, a medical facility, or a tourism company, respectively. When the activity detail is an education detail provided by an educational institution, the activity entity is the educational institution, a language school, or the like. When the activity detail is an examination detail, the activity entity is an organization or the like conducting the examination.

The content mastery degree of each learner is calculated based on: all the learning target contents stored in the second memory 42; and learned contents corresponding to identification information related to the learner stored in the third memory 44. Specifically, the content mastery degree of a learner is calculated according to the formula below.

The content mastery degree of a learner=the number of learned contents corresponding to identification information related to the learner/the number of all learning target contents.

In the present embodiment, the content mastery degree of a learner for each activity detail can be calculated by the processor 20. Such a content mastery degree of a learner for each activity detail is calculated based on: learning target contents related to the activity details out of all the learning target contents stored in the second memory 42; and learned contents related to the activity details out of the learned contents corresponding to identification information related to learners stored in the third memory 44. Specifically, the content mastery degree of a learner for each activity detail is calculated according to the formula below.

The content mastery degree of a learner for each activity detail=the number of learned contents related to an activity detail out of learned contents corresponding to identification information related to the learner/the number of learning target contents related to the activity detail out of all learning target contents.

Next, an operation of a learner who learns a content according to the information processing system 1 of the present embodiment will be described. First, a learner installs a content learning application into the terminal 60 of the learner. Specifically, through the terminal 60 of the learner, the learner accesses a website or an application download site operated by a management company managing the server 10, and downloads the content learning application from the website or the like. Accordingly, the content learning application is installed in the terminal 60 of the learner. Then, the learner performs user registration in the content learning application in the terminal 60 of the learner. When the user registration is performed, a user ID is issued by the processor 20 or the like of the server 10. After the learner inputs the user ID and a password upon activation of the content learning application in the terminal 60 of the learner, the learner can learn a content through the content learning application.

When the learner is to learn a content such as a part forming a character, a character, a vocabulary, or a chunk, the learner first activates the content learning application installed in the terminal 60 of the learner. Then, when the learner inputs a content to be learned by the learner to the terminal 60 of the learner, the inputted content is transmitted as a learning target content from the terminal 60 of the learner to the server 10. When the reception means 22 receives the learning target content, the processor 20 of the server 10 causes the transmission means 30 to transmit to the terminal 60 of the learner various types of information (e.g., how to read, etc.) regarding the learning target content received by the reception means 22 and information on a related content and the like corresponding to the learning target content, based on the information stored in the second memory 42. Accordingly, information related to the inputted content is displayed on the terminal 60 of the learner, so that the learner can learn the content. As described above, when the learner learns, through the terminal 60 of the learner, a certain content out of learning target contents stored in the second memory 42, the storage means 32 causes the third memory 44 to store this content as a learned content that is linked to identification information related to the learner. Here, the identification information related to the learner is the identification number of the learner assigned in advance, the identification number of the terminal 60 of the learner assigned in advance, or the user ID registered in the content learning application installed in the terminal 60 of the learner.

Next, various embodiments of the information processing according to the information processing system 1 of the present embodiment will be described with reference to charts and flowcharts shown in FIG. 2 to FIG. 11.

First, a first embodiment (first information processing) of the information processing according to the information processing system 1 of the present embodiment will be described with reference to a chart shown in FIG. 2 and a flowchart shown in FIG. 3. According to the first information processing, a learner and an activity entity can know the content mastery degree of the learner with respect to a specific activity detail.

A learner who wishes to know the content mastery degree of the learner with respect to a specific activity detail inputs information on the activity detail through the terminal 60 of the learner. Specifically, multiple activity detail candidates are displayed on the terminal 60 of the learner, and the learner can select a certain activity detail from the activity detail candidates through the terminal 60 of the learner. When the learner inputs information on an activity detail through the terminal 60 of the learner, the inputted information on the activity detail and identification information regarding this learner are transmitted from the terminal 60 of the learner to the server 10. Here, as described above, the identification information related to the learner to be transmitted from the terminal 60 of the learner to the server 10 is the identification number of the learner assigned in advance, the identification number of the terminal 60 of the learner assigned in advance, or the user ID registered in the content learning application installed in the terminal 60 of the learner.

In the server 10, when the reception means 22 receives the identification information regarding the learner and the information on the activity detail (“YES” in Step 1 in FIG. 3), the extraction means 24 extracts, based on the information stored in the second memory 42 and the third memory 44, learned contents related to the received activity detail out of learned contents corresponding to the identification information regarding the learner received by the reception means 22 (Step 2). Specifically, first, based on the information stored in the third memory 44, the extraction means 24 extracts learned contents corresponding to the identification information regarding the learner received by the reception means 22. Next, the extraction means 24 extracts only learned contents that are related to the activity detail received by the reception means 22, out of the learned contents corresponding to the identification information regarding the learner. Then, based on the learned contents extracted by the extraction means 24, the calculation means 26 calculates the content mastery degree of the learner with respect to the activity detail received by the reception means 22 (Step 3). Specifically, the content mastery degree of the learner is calculated according to the formula below.

The content mastery degree of the learner of a certain activity detail=the number of learned contents related to this activity detail out of learned contents corresponding to identification information related to the learner/the number of learning target contents related to this activity detail out of all learning target contents.

Then, the transmission means 30 transmits, to the terminal 60 of the learner, a display instruction signal for causing the terminal 60 of the learner to display the content mastery degree of the learner calculated by the calculation means 26 (Step 4). Thus, the content mastery degree of the learner with respect to the activity detail inputted by the learner is displayed on the terminal 60 of the learner. Accordingly, the learner can know the content mastery degree with respect to the specific activity detail.

As another embodiment, when the learner registers a user ID in the content learning application through the terminal 60 of the learner, the learner may also be able to select an activity detail. In this case, information on the selected activity detail is transmitted from the terminal 60 of the learner to the server 10, and the information on this activity detail is linked to the identification information regarding the learner and stored into the third memory 44. In this case, even if the learner who wishes to know the content mastery degree of the learner with respect to a certain activity detail does not input information on the activity detail through the terminal 60 of the learner, the content mastery degree of the learner with respect to the activity detail corresponding to the identification information regarding this learner stored in the third memory 44 is displayed on the terminal 60 of the learner. Accordingly, the learner can know the content mastery degree with respect to the activity detail set at first. The learner may be able to change, through the terminal 60 of the learner, the information on the activity detail selected when the user ID is registered. In this case, the changed information on the activity detail is linked to the identification information regarding the learner and stored into the third memory 44. Then, the content mastery degree of the learner with respect to the changed activity detail stored in the third memory 44 is displayed on the terminal 60 of the learner, even when the learner who wishes to know the content mastery degree of the learner with respect to a certain activity detail does not input information on the activity detail through the terminal 60 of the learner.

In the description above, an embodiment has been described in which, when a learner inputs information on an activity detail through the terminal 60 of the learner, the content mastery degree with respect to this activity detail is displayed on the terminal 60 of the learner. However, the present invention is not limited to this embodiment. Also when an operator who operates a terminal 70 of an activity entity wishes to know the content mastery degree of a certain learner with respect to a specific activity detail, a similar operation is performed.

Specifically, a staff member or the like of an activity entity who wishes to know the content mastery degree of a certain learner with respect to a specific activity detail inputs information on the activity detail and identification information related to the learner through the terminal 70 of the activity detail. When the staff member or the like of the activity entity inputs the information on the activity detail and the identification information related to the learner through the terminal 70 of the activity entity, the inputted information on the activity detail and the inputted identification information regarding the learner are transmitted from the terminal 70 of the activity entity to the server 10. Here, as described above, the identification information related to the learner transmitted from the terminal 70 of the activity entity to the server 10 includes the identification number of the learner assigned in advance, etc.

In the server 10, when the reception means 22 receives the identification information regarding the learner and the information on the activity detail (“YES” in Step 1 in FIG. 3), the extraction means 24 extracts, based on the information stored in the second memory 42 and the third memory 44, learned contents related to the received activity detail out of learned contents corresponding to the identification information regarding the learner received by the reception means 22 (Step 2). Then, based on the learned contents extracted by the extraction means 24, the calculation means 26 calculates the content mastery degree of the learner with respect to the activity detail received by the reception means 22 (Step 3). Then, the transmission means 30 transmits, to the terminal 70 of the activity entity, a display instruction signal for causing the terminal 70 of the activity entity to display the content mastery degree of the learner calculated by the calculation means 26 (Step 4). Thus, the content mastery degree of the learner with respect to the activity detail inputted by the staff member or the like of the activity entity is displayed on the terminal 70 of the activity entity. Accordingly, the staff member or the like of the activity entity can know the content mastery degree of the certain learner with respect to the specific activity detail.

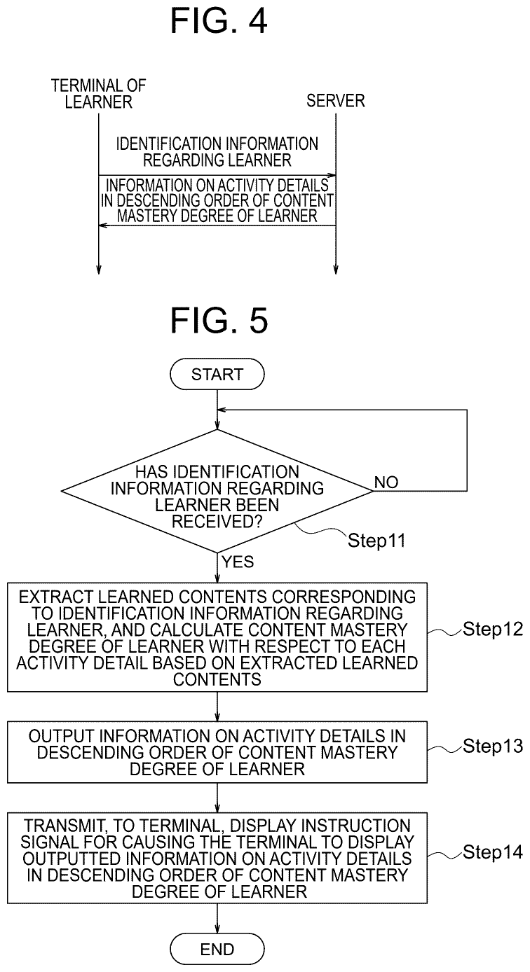

Next, a second embodiment (second information processing) of the information processing according to the information processing system 1 of the present embodiment will be described with reference to a chart shown in FIG. 4 and a flowchart shown in FIG. 5. According to the second information processing, a learner can know information on activity details in the descending order of the mastery degree.

First, a learner inputs, to the terminal 60 of the learner, information indicating that the learner wishes to know information on activity details in the descending order of the content mastery degree. Specifically, when a specific button is pressed in the content learning application executed in the terminal 60 of the learner, information indicating that the learner wishes to know information on activity details in the descending order of the content mastery degree is inputted to the terminal 60 of the learner. When such information is inputted to the terminal 60 of the learner, identification information regarding the learner is transmitted from the terminal 60 of the learner to the server 10. Here, as described above, the identification information related to the learner transmitted from the terminal 60 of the learner to the server 10 includes the identification number of the learner assigned in advance, the identification number of the terminal 60 of the learner assigned in advance, or the user ID registered in the content learning application installed in the terminal 60 of the learner.

In the server 10, when the reception means 22 receives the identification information regarding the learner (“YES” in Step 11 in FIG. 5), the extraction means 24 extracts, based on the information stored in the third memory 44, learned contents corresponding to the identification information regarding the learner received by the reception means 22 (Step 12). Then, based on the information stored in the second memory 42 and the learned contents extracted by the extraction means 24, the calculation means 26 calculates the content mastery degree of the learner with respect to each activity detail. Specifically, the content mastery degree of the learner with respect to each activity detail is calculated according to the formula below (Step 12).

The content mastery degree of the learner of a certain activity detail=the number of learned contents related to this activity detail out of learned contents of the learner/the number of learning target contents related to this activity detail out of all learning target contents.

Then, the output means 28 outputs information on each activity detail in the descending order of the content mastery degree of the learner (Step 13). Then, the transmission means 30 transmits, to the terminal 60 of the learner, a display instruction signal for causing the terminal 60 of the learner to display the information on each activity detail in the descending order of the content mastery degree of the learner outputted by the output means 28. Thus, the information on each activity detail in the descending order of the content mastery degree of the learner is displayed on the terminal 60 of the learner. Accordingly, the learner can know the information on each activity detail in the descending order of the content mastery degree.

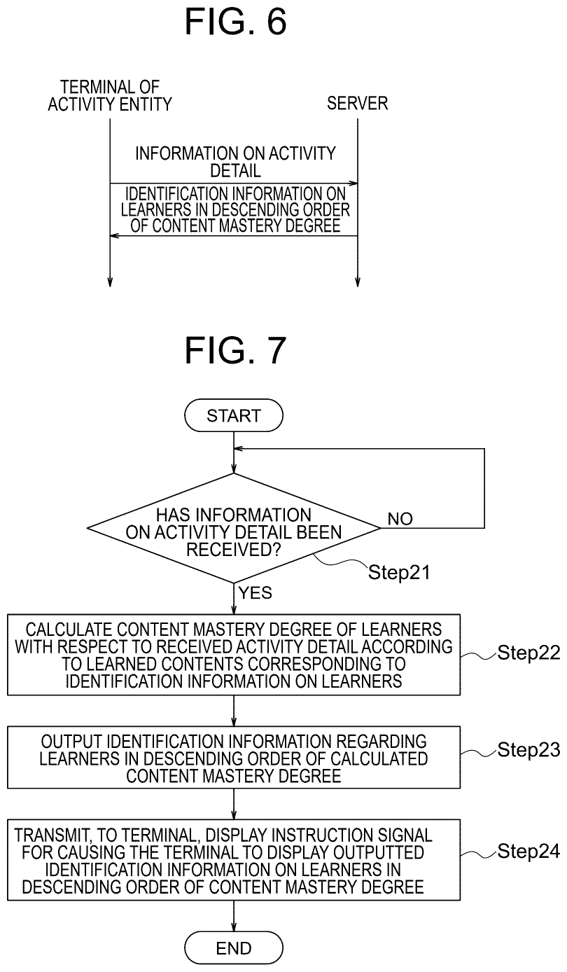

Next, a third embodiment (third information processing) of the information processing according to the information processing system 1 of the present embodiment will be described with reference to a chart shown in FIG. 6 and a flowchart shown in FIG. 7. According to the third information processing, a staff member or the like of an activity entity can know information on learners in the descending order of the content mastery degree with respect to an activity detail related to this activity entity.

When a staff member or the like of an activity entity wishes to know information on learners in the descending order of the content mastery degree with respect to an activity detail related to this activity entity, the staff member or the like inputs information on the activity detail through the terminal 70 of the activity entity. Specifically, multiple activity detail candidates are displayed on the terminal 70 of the activity entity, and the staff member or the like of the activity entity can select a certain activity detail from the activity detail candidates through the terminal 70 of the activity entity. When the staff member or the like of the activity entity inputs information on the activity detail through the terminal 70 of the activity entity, the inputted information on the activity detail is transmitted from the terminal 70 of the activity entity to the server 10.

In the server 10, when the reception means 22 receives the information on the activity detail (“YES” in Step 21 in FIG. 7), the calculation means 26 calculates, based on the information stored in the second memory 42 and the third memory 44, the content mastery degree of each learner with respect to the activity detail received by the reception means 22 according to learned contents corresponding to identification information regarding the learners (Step 22 in FIG. 7). Specifically, the content mastery degree of each learner with respect to the activity detail received by the reception means 22 is calculated according to the formula below.

The content mastery degree of a learner with respect to the activity detail received by the reception means 22=the number of learned contents related to the activity detail received by the reception means 22 out of learned contents of this learner/the number of learning target contents related to this activity detail out of all learning target contents.

Then, the output means 28 outputs the identification information regarding each learner in the descending order of the content mastery degree calculated by the calculation means 26 (Step 23). Then, the transmission means 30 transmits, to the terminal 70 of the activity entity, a display instruction signal for causing the terminal 70 of the activity entity to display the identification information regarding each learner in the descending order of the content mastery degree outputted by the output means 28. Thus, the identification information regarding each learner in the descending order of the content mastery degree is displayed on the terminal 70 of the activity entity. Accordingly, the staff member or the like of the activity entity can know the identification information regarding each learner in the descending order of the content mastery degree.

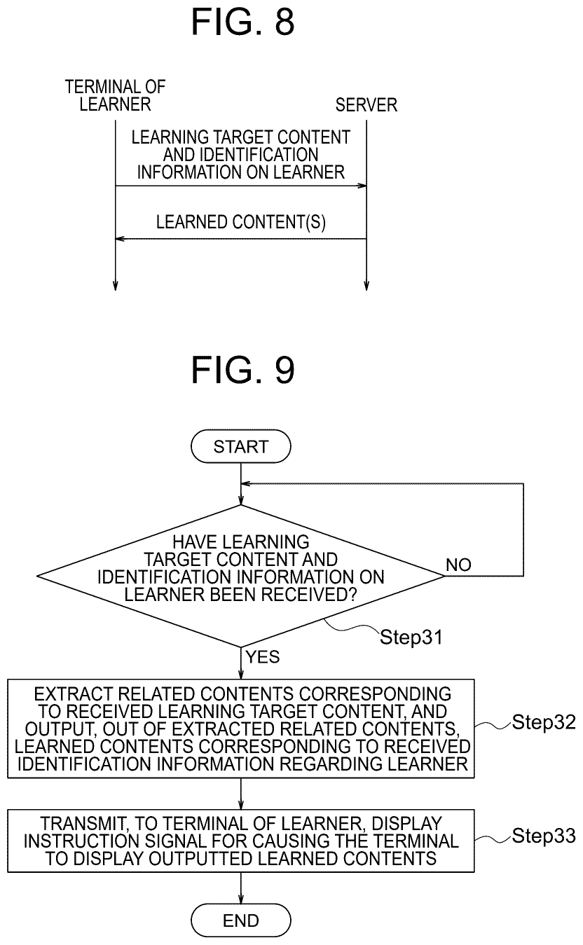

Next, a fourth embodiment (fourth information processing) of the information processing according to the information processing system 1 of the present embodiment will be described with reference to a chart shown in FIG. 8 and a flowchart shown in FIG. 9. According to the fourth information processing, it is possible to know a learned content(s) related to a learning target content to be learned by a learner. Therefore, the learner can review the learned content(s), and thus, can more efficiently learn the content.

When a learner inputs a learning target content to the terminal 60 of the learner in learning a content through the terminal 60 of the learner, the inputted learning target content and identification information regarding this learner are transmitted from the terminal 60 of the learner to the server 10. Here, as described above, the identification information related to the learner transmitted from the terminal 60 of the learner to the server 10 includes the identification number of the learner assigned in advance, the identification number of the terminal 60 of the learner assigned in advance, or the user ID registered in the content learning application installed in the terminal 60 of the learner.

In the server 10, when the reception means 22 receives the learning target content and the identification information regarding the learner (“YES” in Step 31 in FIG. 9), the extraction means 24 extracts, based on the information stored in the second memory 42, related contents corresponding to the learning target content received by the reception means 22 (Step 32 in FIG. 9). As described above, the term related content is a content stored in the second memory 42 and related to the learning target content received by the reception means 22 in terms of pronunciation, shape, or meaning. Then, the output means 28 outputs, out of the related contents extracted by the extraction means 24, contents that match learned contents corresponding to the identification information regarding the learner received by the reception means 22 (Step 32 in FIG. 9).

Then, the transmission means 30 transmits, to the terminal 60 of the learner, a display instruction signal for causing the terminal 60 of the learner to display the learned contents outputted by the output means 28 (Step 33 in FIG. 9). Accordingly, the learned contents related to the inputted learning target content are displayed on the terminal 60 of the learner. In this case, by knowing the learned contents related to the inputted learning target content, the learner can review the learned contents. This enables more efficient content learning.

The learned contents corresponding to identification information stored in the third memory 44 may also be stored in the second memory 42. In this case, based on the information stored in the second memory 42, the extraction means 24 extracts related contents corresponding to the learning target content received by the reception means 22. Then, the output means 28 outputs learned contents corresponding to identification information regarding another learner based on the information stored in the second memory 42 and the related contents extracted by the extraction means 24. Then, the transmission means 30 transmits, to the terminal 60 of the learner, a display instruction signal for causing the terminal 60 of the learner to display the learned contents outputted by the output means 28. Accordingly, the learned contents related to the inputted learning target content are displayed on the terminal 60 of the learner. In this case, the learner can also know the learned contents related to the other learner. This enables further efficient content learning.

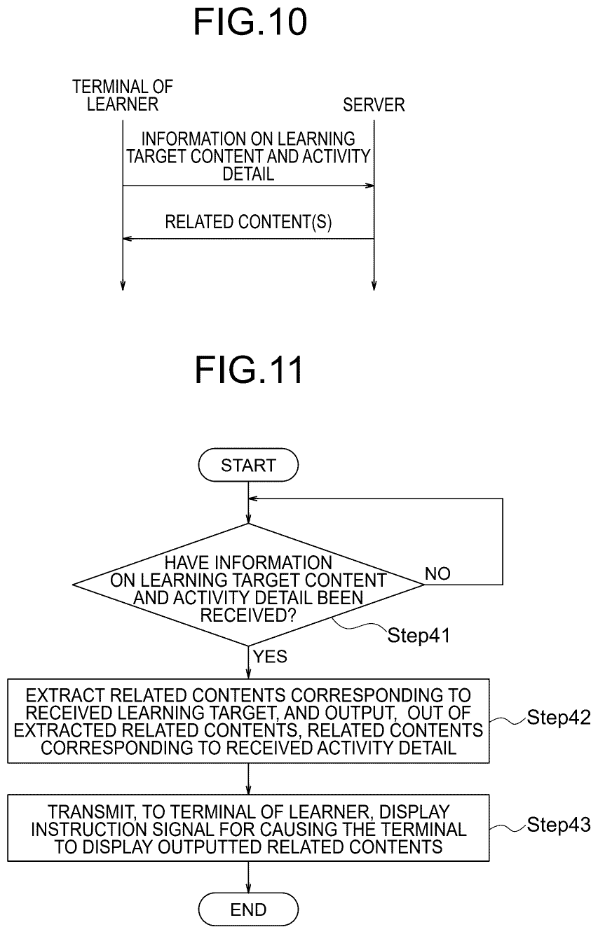

Next, a fifth embodiment (fifth information processing) of the information processing according to the information processing system 1 of the present embodiment will be described with reference to a chart shown in FIG. 10 and a flowchart shown in FIG. 11. According to the fifth information processing, a learner can know a related content(s) related to an inputted activity detail.

When a learner inputs information on a learning target content and an activity detail to the terminal 60 of the learner in learning a content through the terminal 60 of the learner, the inputted information on the learning target content and the activity detail are transmitted from the terminal 60 of the learner to the server 10. Specifically, multiple activity detail candidates are displayed on the terminal 60 of the learner, and the learner can select a certain activity detail from the activity detail candidates through the terminal 60 of the learner. As described above, in the case where the information on the activity detail is linked to identification information related to the learner and stored in the third memory 44, when the learner inputs information on a learning target content to the terminal 60 of the learner in learning a content through the terminal 60 of the learner, the inputted information on the learning target content is transmitted from the terminal 60 of the learner to the server 10.

When the reception means 22 receives the information on the learning target content and the activity detail (“YES” in Step 41 in FIG. 11), the extraction means 24 extracts, based on the information stored in the second memory 42, related contents corresponding to the received learning target content. As described above, the term related content is a content stored in the second memory 42 and related to the learning target content received by the reception means 22 in terms of pronunciation, shape, or meaning. Then, the output means 28 outputs, out of the related contents extracted by the extraction means 24, related contents corresponding to the activity detail received by the reception means 22 (Step 42 in FIG. 11).

Then, the transmission means 30 transmits, to the terminal 60 of the learner, a display instruction signal for causing the terminal 60 of the learner to display the related contents outputted by the output means 28 (Step 43 in FIG. 11). Accordingly, the related contents related to the inputted learning target content and corresponding to the inputted activity detail are displayed on the terminal 60 of the learner. In this case, by knowing the related contents related to the inputted learning target content and corresponding to the inputted activity detail, the learner can learn the related contents regarding the specific activity detail. This enables more efficient content learning of the specific activity detail.

In the case where the information on the activity detail is linked to identification information related to the learner and stored in the third memory 44, the output means 28 outputs, out of the related contents extracted by the extraction means 24, related contents corresponding to the activity detail stored in the third memory 44. Then, the transmission means 30 transmits, to the terminal 60 of the learner, a display instruction signal for causing the terminal 60 of the learner to display the related contents outputted by the output means 28. Accordingly, the terminal 60 of the learner displays the related contents that are related to the inputted learning target content and that correspond to the activity detail linked to the identification information related to the learner and stored in the third memory 44.

According to the information processing device (specifically, the server 10) and the information processing method of the present embodiment which have features as described above, the server 10 includes: the processor 20; the first memory 40 configured to store a program; the second memory 42 configured to store learning target contents and activity details respectively related to the learning target contents; and the third memory 44 configured to store learned contents corresponding to identification information regarding learners. Through execution of the program stored in the first memory 40, the processor 20 is configured to receive, from a terminal 60 of a learner, information on a content having been learned, and cause the third memory 44 to store the received content as a learned content in association with identification information regarding the learner. According to the information processing device and the information processing method, the content learned by the learner is linked to identification information regarding this learner and stored as a learned content in the third memory 44, so that the learned content stored in the third memory 44 can be utilized.

In the information processing device (specifically, the server 10) and the information processing method of the present embodiment, as described above, the learning target content may include at least one of a vocabulary and a chunk.

In the information processing device (specifically, the server 10) and the information processing method of the present embodiment, as described above, the identification information regarding a learner may include an identification number of the learner assigned in advance, an identification number of the terminal of the learner assigned in advance, or a user ID registered in a content learning application installed in the terminal of the learner.

In the information processing device (specifically, the server 10) and the information processing method of the present embodiment, as described above, through execution of the program stored in the first memory 40, the processor 20 is configured to: receive identification information regarding a learner and information on an activity detail; extract, based on the information stored in the second memory 42 and the third memory 44, a learned content related to the received activity detail out of a learned content corresponding to the received identification information regarding the learner; and calculate, based on the extracted learned content, a content mastery degree of the learner with respect to the received activity detail. In this case, based on the learned content(s) of the learner stored in the third memory 44, information regarding the content mastery degree of the learner with respect to a specific activity detail can be obtained.

In the information processing device (specifically, the server 10) and the information processing method of the present embodiment, as described above, through execution of the program stored in the first memory 40, the processor 20 is configured to transmit, to a terminal (specifically, the terminal 60 of the learner or the terminal 70 of the activity entity), a display instruction signal for causing this terminal to display the calculated content mastery degree of the learner. Accordingly, the calculated content mastery degree of the learner can be displayed on the terminal such as the terminal 60 of the learner or the terminal 70 of the activity entity. Thus, the learner or a staff member or the like of the activity entity can know the calculated content mastery degree of the learner.

In the information processing device (specifically, the server 10) and the information processing method of the present embodiment, as described above, through execution of the program stored in the first memory 40, the processor 20 is configured to: receive information on identification information regarding a learner; extract, based on the information stored in the third memory 44, learned contents corresponding to the received identification information regarding the learner; calculate, based on the information stored in the second memory 42 and the extracted learned contents, a content mastery degree of the learner with respect to each activity detail; and output information on said each activity detail in a descending order of the calculated content mastery degree of the learner. Accordingly, based on learned contents of learners stored in the third memory 44, the content mastery degree of a certain learner with respect to each activity detail can be calculated. In this case, for example, the learner can recognize an activity detail that the learner is good at (the content mastery degree is high).

In the information processing device (specifically, the server 10) and the information processing method of the present embodiment, as described above, through execution of the program stored in the first memory 40, the processor 20 is configured to transmit, to a terminal (specifically, for example, the terminal 60 of the learner), a display instruction signal for causing this terminal to display the outputted information on said each activity detail in the descending order of the content mastery degree of the learner. Accordingly, the learner or the like can know the calculated content mastery degree with respect to each activity detail.

In the information processing device (specifically, the server 10) and the information processing method of the present embodiment, as described above, through execution of the program stored in the first memory 40, the processor 20 is configured to: receive information on an activity detail; calculate, based on the information stored in the second memory 42 and the third memory 44, a content mastery degree of each learner with respect to the received activity detail according to the learned contents corresponding to identification information regarding learners; and output identification information regarding said each learner in a descending order of the calculated content mastery degree. Accordingly, based on learned contents of learners stored in the third memory 44, identification information regarding each learner can be outputted in the descending order of the content mastery degree with respect to a certain activity detail.

In the information processing device (specifically, the server 10) and the information processing method of the present embodiment, as described above, through execution of the program stored in the first memory 40, the processor 20 is configured to transmit, to a terminal (e.g., the terminal 70 of the activity entity), a display instruction signal for causing this terminal to display the outputted identification information regarding said each learner in the descending order of the content mastery degree. Accordingly, a staff member or the like of the activity entity can know the identification information regarding each learner in the descending order of the content mastery degree with respect to an activity detail of this activity entity.

In the information processing device (specifically, the server 10) and the information processing method of the present embodiment, the server 10 includes: the processor 20; the first memory 40 configured to store a program; the second memory 42 configured to store learning target contents and related contents respectively to the learning target contents; and the third memory 44 configured to store learned contents corresponding to identification information regarding learners. Through execution of the program stored in the first memory 40, the processor 20 is configured to: receive a learning target content and identification information regarding a learner; extract, based on the information stored in the second memory 42, a related content corresponding to the received learning target content; and output, based on the information stored in the third memory 44 and out of the extracted related content, a learned content corresponding to the received identification information regarding the learner. Accordingly, based on learned contents stored in the third memory 44, the content that is a related content to the learning target content to be learned by the learner and that has been learned by the learner can be outputted. Therefore, the learner can review the learned content(s), and thus, the learner can more efficiently learn the content.

In the information processing device (specifically, the server 10) and the information processing method of the present embodiment, as described above, through execution of the program stored in the first memory 40, the processor 20 is configured to transmit, to the terminal 60 of the learner, a display instruction signal for causing the terminal 60 of the learner to display the outputted learned content. Accordingly, the learner can see the learned content displayed on the terminal 60 of the learner.

In the information processing device (specifically, the server 10) and the information processing method of the present embodiment, as described above, the learned contents corresponding to identification information stored in the third memory 44 are also stored in the second memory 42. After the related content corresponding to the received learning target content is extracted based on the information stored in the second memory 42, a learned content corresponding to identification information regarding another learner is also allowed to be outputted based on the information stored in the second memory 42 and out of the extracted related content. In this case, a related content to the learning target content to be learned by the learner can be outputted with reference to the learned content corresponding to the identification information regarding the other learner, also. Therefore, the learner can further efficiently learn the content.

In the information processing device (specifically, the server 10) and the information processing method of the present embodiment, the server 10 includes: the processor 20; the first memory 40 configured to store a program; and the second memory 42 configured to store learning target contents, related contents respectively to the learning target contents and activity details respectively related to the learning target contents. Through execution of the program stored in the first memory 40, the processor 20 is configured to: receive information on a learning target content and an activity detail from a terminal of a learner; extract, based on the information stored in the second memory 42, a related content corresponding to the received learning target content; and output, out of the extracted related content, a related content corresponding to the received activity detail. Accordingly, the learner can know a related content that is related to the learning target content and the activity detail inputted when learning the content through the terminal 60 of the learner.

In the information processing device (specifically, the server 10) and the information processing method of the present embodiment, as described above, through execution of the program stored in the first memory 40, the processor 20 is configured to transmit, to the terminal 60 of the learner, a display instruction signal for causing the terminal 60 of the learner to display the outputted related content. Accordingly, the learner can see the related content displayed on the terminal 60 of the learner.

It should be noted that the information processing device (the server 10) and the information processing method according to the present invention are not limited to the embodiments described above, and various changes can be made thereto.

For example, in the descriptions above, the embodiment in which the first memory 40, the second memory 42, and the third memory 44 are separately provided has been described. However, the present embodiment is not limited to such an embodiment. Two memories out of the first memory 40, the second memory 42, and the third memory 44 may be integrated, or three memories, i.e., the first memory 40, the second memory 42, and the third memory 44, may be integrated.

The program executed by the processor 20 of the server 10 need not necessarily be stored in the first memory 40. The program executed by the processor 20 of the server 10 may be transmitted from a device provided separately from the server 10. Alternatively, the program may be stored in a storage device, an external database, or the like provided separately from the server 10, and read out by the processor 20 as needed.

The learning target contents and the activity details respectively related to the learning target contents need not necessarily be stored in the second memory 42. The learning target contents and the activity details respectively related to the learning target contents may be stored in a storage device, an external database, or the like provided separately from the server 10, and the processor 20 may read out, as needed, the learning target contents and the activity details respectively related to the learning target contents stored in the storage device, the external database, or the like.

The learned contents corresponding to identification information regarding learners need not necessarily be stored in the third memory 44. The learned contents corresponding to identification information regarding learners may be stored in a storage device, an external database, or the like provided separately from the server 10, and the processor 20 may read out, as needed, the learned contents corresponding to identification information regarding learners stored in the storage device, the external database, or the like.

In the information stored in the second memory 42, a score (0 to 1) indicating the degree of relatedness to each activity detail may be stored for each learning target content. In this case, when the extraction means 24 is to extract a learned content related to the received activity detail out of learned contents corresponding to the identification information regarding the learner received by the reception means 22, the extraction means 24 extracts the learned content with reference to the score, stored in the second memory 42, indicating the degree of relatedness between activity details and learning target contents. Further, when the calculation means 26 is to calculate the content mastery degree of the learner with respect to each activity detail based on the information stored in the second memory 42 and learned contents extracted by the extraction means 24, the calculation means 26 calculates the content mastery degree of the learner with respect to each activity detail with reference to the score, stored in the second memory 42, indicating the degree of relatedness between activity details and learning target contents.

In the information processing system 1 of the present invention, a record of learned contents of each learner may be added as one of materials for another matching system. For example, in a matching system used in an outplacement company or a temporary staffing company, skills indicating the ability, academic background, etc. of each user are recorded as information on the user. The learned contents of each learner outputted by the information processing device (e.g., the server 10) of the present invention may also be added as one of materials indicating the ability of each user.

In the information processing system 1 of the present invention, a specific learning content may be provided from each activity entity side to a learner, and the third memory 44 may store the provided learning content as a learned content. For example, in a case where the activity entity is an educational institution such as a school, an enterprise performing in-house training, or the like, the third memory 44 can collectively store education details provided by the activity entity to a learner as learned contents in association with identification information regarding the learner. In this case, the learning contents provided from the activity entity to the learner may be limited to learning contents related to the activity detail of the activity entity stored in the second memory 42.

In the information processing system 1 of the present invention, based on contents of learners stored in the third memory 44, matching between learners may be performed by the processor 20. For example, a Japanese learner who learns English as a foreign language may be matched with a Mexican who learns English and who has the same learning level as that of this Japanese learner, whereby opportunities of interaction in English or provision of education details may be given by the server 10.

1. An information processing device comprising:
a processor;
a first memory configured to store a program;
a second memory configured to store learning target contents and activity details respectively related to the learning target contents; and
a third memory configured to store learned contents corresponding to identification information regarding learners, wherein
each activity detail includes any of a type of business run by a corporation or an individual, a type of job, and an education detail provided by an educational institution, and an examination detail provided by an educational institution,
each content includes a vocabulary, and a chunk as an assembly of vocabularies that means a collective body of information recognized by humans, and
through execution of the program stored in the first memory, the processor is configured to
receive, from a terminal of a learner, information on a content having been learned,
cause the third memory to store the received content as a learned content in association with identification information regarding the learner,
receive identification information regarding a learner and information on an activity detail,
extract, based on the information stored in the second memory and the third memory, a learned content related to the received activity detail out of a learned content corresponding to the received identification information regarding the learner, and
calculate, based on the extracted learned content, a content mastery degree of the learner with respect to the received activity detail.

2. (canceled)

3. The information processing device according to claim 1, wherein
through execution of the program stored in the first memory, the processor is configured to
transmit, to a terminal, a display instruction signal for causing the terminal to display the calculated content mastery degree of the learner.

4-20. (canceled)

21. An information processing device comprising:
a processor;
a first memory configured to store a program;
a second memory configured to store learning target contents and activity details respectively related to the learning target contents; and
a third memory configured to store learned contents corresponding to identification information regarding learners, wherein
each activity detail includes any of a type of business run by a corporation or an individual, a type of job, and an education detail provided by an educational institution, and an examination detail provided by an educational institution,
each content includes a vocabulary, and a chunk as an assembly of vocabularies that means a collective body of information recognized by humans, and
through execution of the program stored in the first memory, the processor is configured to
receive, from a terminal of a learner, information on a content having been learned,
cause the third memory to store the received content as a learned content in association with identification information regarding the learner,
receive information on identification information regarding a learner,
extract, based on the information stored in the third memory, learned contents corresponding to the received identification information regarding the learner,
calculate, based on the information stored in the second memory and the extracted learned contents, a content mastery degree of the learner with respect to each activity detail, and
output information on said each activity detail in a descending order of the calculated content mastery degree of the learner.

22. The information processing device according to claim 21, wherein
through execution of the program stored in the first memory, the processor is configured to
transmit, to a terminal, a display instruction signal for causing the terminal to display the outputted information on said each activity detail in the descending order of the content mastery degree of the learner.

23. An information processing device comprising:
a processor;
a first memory configured to store a program;
a second memory configured to store learning target contents and activity details respectively related to the learning target contents; and
a third memory configured to store learned contents corresponding to identification information regarding learners, wherein
each activity detail includes any of a type of business run by a corporation or an individual, a type of job, and an education detail provided by an educational institution, and an examination detail provided by an educational institution,
each content includes a vocabulary, and a chunk as an assembly of vocabularies that means a collective body of information recognized by humans, and
through execution of the program stored in the first memory, the processor is configured to
receive, from a terminal of a learner, information on a content having been learned,
cause the third memory to store the received content as a learned content in association with identification information regarding the learner,
receive information on an activity detail,
calculate, based on the information stored in the second memory and the third memory, a content mastery degree of each learner with respect to the received activity detail according to the learned contents corresponding to identification information regarding learners, and
output identification information regarding said each learner in a descending order of the calculated content mastery degree.

24. The information processing device according to claim 21, wherein
through execution of the program stored in the first memory, the processor is configured to
transmit, to a terminal, a display instruction signal for causing the terminal to display the outputted identification information regarding said each learner in the descending order of the content mastery degree.

25. The information processing device according to claim 1, wherein
the identification information regarding a learner includes an identification number of the learner assigned in advance, an identification number of the terminal of the learner assigned in advance, or a user ID registered in a content learning application installed in the terminal of the learner.

26. An information processing device comprising:
a processor;
a first memory configured to store a program;
a second memory configured to store learning target contents and related contents respectively to the learning target contents; and
a third memory configured to store learned contents corresponding to identification information regarding learners, wherein
each content includes a part forming a character, a character, a vocabulary, and a chunk as an assembly of vocabularies that means a collective body of information recognized by humans,
each related content includes a content related to the corresponding learning target content in terms of pronunciation, shape, or meaning, and
through execution of the program stored in the first memory, the processor is configured to
receive a learning target content and identification information regarding a learner,
extract, based on the information stored in the second memory, a related content corresponding to the received learning target content, and
output, based on the information stored in the third memory and out of the extracted related content, a learned content corresponding to the received identification information regarding the learner.

27. The information processing device according to claim 26, wherein
through execution of the program stored in the first memory, the processor is configured to
transmit, to a terminal of the learner, a display instruction signal for causing the terminal to display the outputted learned content.

28. The information processing device according to claim 26, wherein
the learned contents corresponding to identification information stored in the third memory are also stored in the second memory, and
after the related content corresponding to the received learning target content is extracted based on the information stored in the second memory, a learned content corresponding to identification information regarding another learner is also allowed to be outputted based on the information stored in the second memory and out of the extracted related content.

29. An information processing device comprising:
a processor;
a first memory configured to store a program; and
a second memory configured to store learning target contents, related contents respectively to the learning target contents, and activity details respectively related to the learning target contents, wherein
each activity detail includes any of a type of business run by a corporation or an individual, a type of job, and an education detail provided by an educational institution, and an examination detail provided by an educational institution,
each content includes a part forming a character, a character, a vocabulary, and a chunk as an assembly of vocabularies that means a collective body of information recognized by humans,
each related content includes a content related to the corresponding learning target content in terms of pronunciation, shape, or meaning, and
through execution of the program stored in the first memory, the processor is configured to
receive information on a learning target content and an activity detail from a terminal of a learner,
extract, based on the information stored in the second memory, a related content corresponding to the received learning target content, and
output, out of the extracted related content, a related content corresponding to the received activity detail.

30. The information processing device according to claim 29, wherein
through execution of the program stored in the first memory, the processor is configured to
transmit, to the terminal of the learner, a display instruction signal for causing the terminal to display the outputted related content.
